(19) United States
(12) Patent Application Publication
(10) Pub. No.: US 2026/0159173 A1
(43) Pub. Date: Jun. 11, 2026

(54) LOWER STRUCTURE OF VEHICLE

(71) Applicant: MAZDA MOTOR CORPORATION, Hiroshima (JP)

(72) Inventor: Eiji KAMEMOTO, Hiroshima (JP)

(73) Assignee: MAZDA MOTOR CORPORATION, Hiroshima (JP)

(21) Appl. No.: 19/178,611

(22) Filed: Apr. 14, 2025

(30) Foreign Application Priority Data
Jun. 7, 2024 (JP) 2024-093034

(51) Int. Cl. B62D 21/15; B62D 25/02; B62D 25/20

(52) U.S. Cl. CPC B62D 21/157; B62D 25/025; B62D 25/2036

(57) ABSTRACT

A pair of right-and-left side sills, cross members extending in a vehicle width direction between the side sills, and a reinforcement extending in a vehicle longitudinal direction inside a closed-cross section of each of the pair of side sills are provided. The reinforcement includes a lateral wall portion expanding in the vehicle longitudinal direction and in the vehicle width direction, has a first area portion which overlaps the cross members in the vehicle longitudinal direction and a second area portion which does not overlap the cross members in the vehicle longitudinal direction, and surface stiffness of the lateral wall portion at the second area portion is larger than that of the lateral wall portion at the first area portion.

### BACKGROUND OF THE INVENTION

The present invention relates to a lower structure of a vehicle.

It has been considered to arrange a reinforcing member inside a side sill as countermeasures for a pole side-collision of a vehicle.

Japanese Patent Laid-Open Publication No. 2021-024350, for example, discloses a vehicle-body structure in which a reinforcing member (reinforcement) having a continuous-cylindrical structure in which plural polygonal-shaped closed-cross sections are continuous when viewed in a vehicle width direction and a deformation-control member to control deformation, in a vehicle longitudinal direction, of the continuous-cylindrical structure of the reinforcing member are arranged inside a side sill extending in a vehicle longitudinal direction.

In the vehicle-body structure of the above-described patent document, the load (load-bearing) capacity along the vehicle width direction is improved by the cylindrical structure of the reinforcement. Further, in the vehicle-body structure of the above-described patent document, the bending deformation of the reinforcement is suppressed by the deformation-control member in the vehicle side collision. However, if a whole part of the reinforcement is constituted by the cylindrical structure, a gross area of the reinforcement becomes too large, and therefore the vehicle-body weight may increase improperly. Further, since it is necessary to provide the deformation-control member additionally in the vehicle-body structure of the above-described patent document, providing the deformation-control member further increases the vehicle-body weight.

### SUMMARY OF THE INVENTION

The present invention has been devised in view of the above-described matter and an object of the present invention is to provide a lower structure of a vehicle which can properly improve the absorption amount of a collision load in the vehicle side collision, suppressing an increase of the vehicle-body weight.

The present invention is a lower structure of a vehicle, comprising a pair of right-and-left side sills extending in a vehicle longitudinal direction and having a closed-cross section, cross members extending in a vehicle width direction between the pair of side sills and provided to be separated from each other in the vehicle longitudinal direction, and a reinforcement extending in the vehicle longitudinal direction inside the closed-cross section of each of the pair of side sills at a position, in a vertical direction, thereof which overlaps the cross members and reinforcing the side sill, wherein the reinforcement includes a lateral wall portion expanding in the vehicle longitudinal direction and in the vehicle width direction, has a first area portion which overlaps the cross members in the vehicle longitudinal direction and a second area portion which does not overlap the cross members in the vehicle longitudinal direction, and surface stiffness (rigidity) of the lateral wall portion at the second area portion is larger than that of the lateral wall portion at the first area portion.

According to the present invention, when the pole-side collision occurs at the first area portion, the collision load can be efficiently transmitted to the cross member by the first area portion. Meanwhile, when the pole-side collision occurs at the second area portion, the absorption amount of the collision load can be improved by the lateral wall portion with the relatively-large surface stiffness (rigidity). Further, since the lateral wall portion is provided just as the reinforcement, the increase of the vehicle-body weight can be suppressed. Accordingly, the lower structure can properly improve the absorption amount of the collision load in the vehicle side collision, suppressing the increase of the vehicle-body weight.

In an embodiment of the present invention, the lateral wall portion at the second area portion has an arc-shaped bead which protrudes in the vertical direction.

According to this embodiment, the surface stiffness can be increased by the bead. Further, the weight increase of the lateral wall portion is small even if the bead is formed. Accordingly, the lower structure can properly improve the absorption amount of the collision load in the vehicle side collision, suppressing the increase of the vehicle-body weight.

In another embodiment of the present invention, the lateral wall portion at the second area portion has a ridgeline portion which extends in the vehicle width direction.

According to this embodiment, the surface stiffness can be increased by the ridgeline portion. Further, the weight increase of the lateral wall portion is small even if the ridgeline portion is formed, because the ridgeline can be just formed by bending process of the lateral wall portion. Accordingly, the lower structure can properly improve the absorption amount of the collision load in the vehicle side collision, suppressing the increase of the vehicle-body weight.

In another embodiment of the present invention, the lateral wall portion comprises an upper-side lateral wall portion which is provided at a relatively upper side and a lower-side lateral wall portion which is provided at a relatively lower side, and each of the upper-side lateral wall portion and the lower-side lateral wall portion at the second area portion has the above-described bead.

According to this embodiment, since the surface stiffness of each of the upper-side lateral wall portion and the lower-side lateral wall portion increases, the lower structure can improve the absorption amount of the collision load in the vehicle side collision.

In another embodiment of the present invention, an upper-side bead as the bead provided at the upper-side lateral wall portion is configured to be recessed downward, a lower-side bead as the bead provided at the lower-side lateral wall portion is configured to be recessed upward, and the upper-side bead and the lower-side bead overlap each other in a plan view.

According to this embodiment, when the lateral wall portion is deformed in the vehicle side collision, the upper-side bead is deformed such that it protrudes downward and the lower-side bead is deformed such that it protrudes upward. Since the upper-side bead and the lower-side bead overlap each other in the plan view, the upper-side bead and the lower-side bead contact each other due to their deformations. Thereby, the compressive deformation of the lateral wall portion does not occur easily, so that the absorption amount of the collision load is improved. The lower structure can improve the absorption amount of the collision load in the vehicle side collision.

In another embodiment of the present invention, an apex portion of the upper-side bead and another apex portion of the lower-side bead overlap each other in the plan view.

According to this embodiment, the upper-side bead and the lower-side bead contact each other in an early stage in the vehicle side collision. Accordingly, the lower structure can improve the absorption amount of the collision load in the vehicle side collision.

In another embodiment of the present invention, the bead is of a polygonal shape in a plan view.

According to this embodiment, the ridgeline extending in the vehicle width direction can be formed at the same time of the bead forming. Further, the beads can be arranged closely, compared to a case where the bead is of a circular shape. Accordingly, the lower structure can improve the absorption amount of the collision load in the vehicle side collision.

In another embodiment of the present invention, the bead is of a triangular shape or a rectangular shape in the plan view.

According to this embodiment, the beads can be arranged closely. Accordingly, the lower structure can improve the absorption amount of the collision load in the vehicle side collision.

In another embodiment of the present invention, the lateral wall portion at the first area portion has a ridgeline portion which extends in the vehicle width direction.

According to this embodiment, since the rigidity against the collision load applied in the vehicle width direction is increased by the ridgeline portion, the collision load can be efficiently transmitted to the cross member. Further, since the ridgeline portion is compressively deformed, the collision load can be absorbed. Also, since the ridgeline portion can be formed just by the bending process, forming of the ridgeline portion does not increase the weight of the lateral wall portion very much. Accordingly, the lower structure can improve the absorption amount of the collision load in the vehicle side collision, suppressing the vehicle-body weight.

In another embodiment of the present invention, the lateral wall portion comprises an upper-side lateral wall portion which is provided at a relatively upper side and a lower-side lateral wall portion which is provided at a relatively lower side, the reinforcement further includes a pair of right-and-left vertical wall portion which connect respective right-side end portions of the upper-side lateral wall portion and the lower-side lateral wall portion and respective left-side end portions of the upper-side lateral wall portion and the lower-side lateral wall portion in the vertical direction, and the upper-side lateral wall portion, lower-side lateral wall portion, and the pair of right-and-left vertical wall portions are integrated.

According to this embodiment, since it is suppressed that the lateral wall portion is bending-deformed by the vertical wall portion, the lower structure can improve the absorption amount of the collision load in the vehicle side collision.

As described above, the lower structure according to the present invention can properly improve the absorption amount of the collision load in the vehicle side collision, suppressing the increase of the vehicle-body weight.

The present invention will become apparent from the following description which refers to the accompanying drawings.

### BRIEF DESCRIPTION OF THE DRAWINGS

FIG. 1 is a plan view showing a vehicle body of a vehicle equipped with a lower structure according to an exemplified embodiment.

FIG. 2 is a plan view around a right-side side sill, when viewed from an upper side.

FIG. 3 is a sectional view taken along lone III-III of FIG. 2.

FIG. 4 is a sectional view taken along lone IV-IV of FIG. 2.

FIG. 5 is a schematic view showing a structure of a reinforcement.

FIG. 6 is a perspective view of a first area portion of the reinforcement.

FIG. 7 is a sectional view taken along lone VII-VII of FIG. 3.

FIG. 8 is a sectional view taken along lone VIII-VIII of FIG. 2.

FIG. 9 is a perspective view of a second area portion of the reinforcement.

FIG. 10 is a plan view of the second area portion of the reinforcement.

FIG. 11 is a sectional view taken along lone XI-XI of FIG. 10.

FIG. 12 is a sectional view showing a deformation state of the second area portion of the reinforcement in a vehicle side collision, which occurs just after collision of a collision object.

FIG. 13 is a sectional view showing a deformation state of the second area portion of the reinforcement in the vehicle side collision, which occurs when the collision object comes in toward an inward side, in a vehicle width direction, of a vehicle body subsequently to the collision of the collision object.

### DETAILED DESCRIPTION OF THE INVENTION

Hereafter, exemplified embodiments of the present invention will be described specifically referring to the drawings. In the following description, respective positions (directions) of front, rear, left, right, upper and lower relative to a vehicle 1 will be merely referred to as the “front,” “rear,” “left,” “right,” “upper” and “lower.” A lateral direction corresponds to a vehicle width direction.

### (1) Whole Structure of Lower Portion of Vehicle

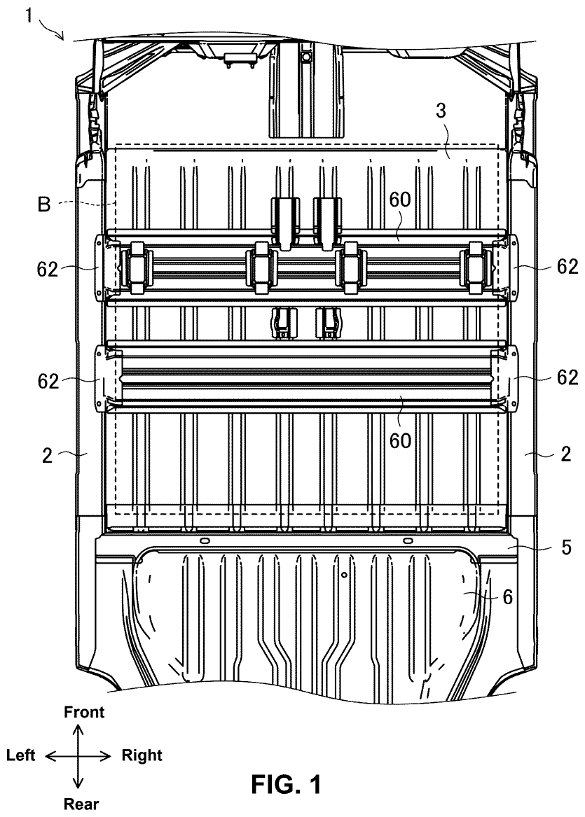

FIG. 1 shows a lower vehicle body of the vehicle 1 provided with a lower structure according to the present embodiment. The vehicle 1 is a four-door type passenger vehicle. In the present embodiment, the vehicle 1 has a laterally-symmetrical vehicle-body structure.

The vehicle 1 comprises a pair of right-and-left side sills 2. Each of the pair of side sills 2 extends straightly in a longitudinal direction. The side sill 2 has a structure having a closed-cross section, and the closed-cross section extends straightly in the longitudinal direction, which will be specifically described later.

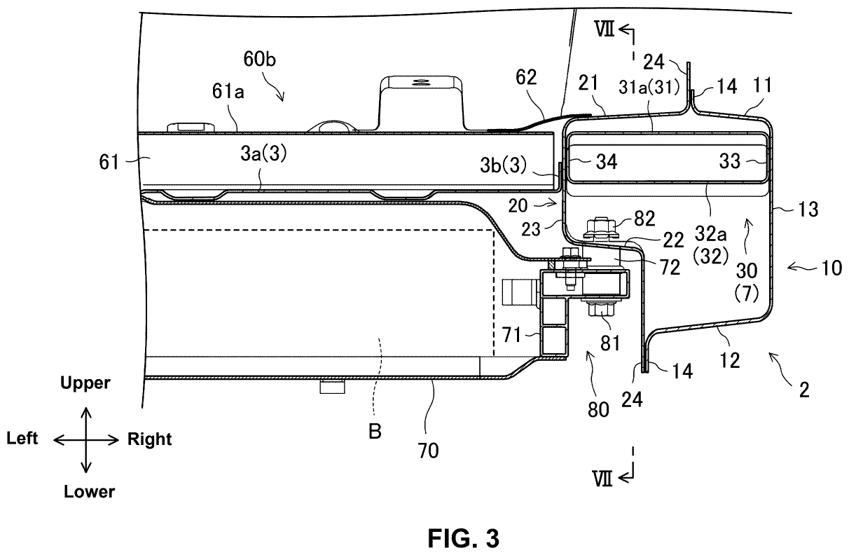

The vehicle 1 comprises a floor panel 3 which forms a floor face of a cabin. The floor panel 3 comprises a floor panel body 3a (see FIG. 3 and others) which expands in the vehicle width direction and in the longitudinal direction and floor-panel joint portions 3b (see FIG. 3 and others) which are fixed to the side sills 2 by welding. The left-side floor-panel joint portion 3b is fixedly welded to a right-side portion of the left-side side sill 2. The right-side floor-panel joint portion 3b is fixedly welded to a left-side portion of the right-side side sill 2.

A kick-up portion 5 which rises upward is arranged at a rear end of the floor panel 3. A rear floor panel 6 expands rearward from the kick-up portion 5. The rear floor panel 6 forms a floor face of a luggage room mainly.

Two cross members 60 extending in the lateral direction are arranged above the floor panel 3. The two cross members 60 are aligned such that they are separated from each other in the longitudinal direction. A longitudinal position of the rear-side cross member 60 is the same as that of a center pillar, which is not illustrated. Hereinafter, the cross member 60 positioned at a relatively front side will be referred to as a front-side cross member 60a and the cross member 60 positioned at a relatively rear side will be referred to as a rear-side cross member 60b in some cases. In a case where these are not differentiated, an expression of the cross member 60 will be used.

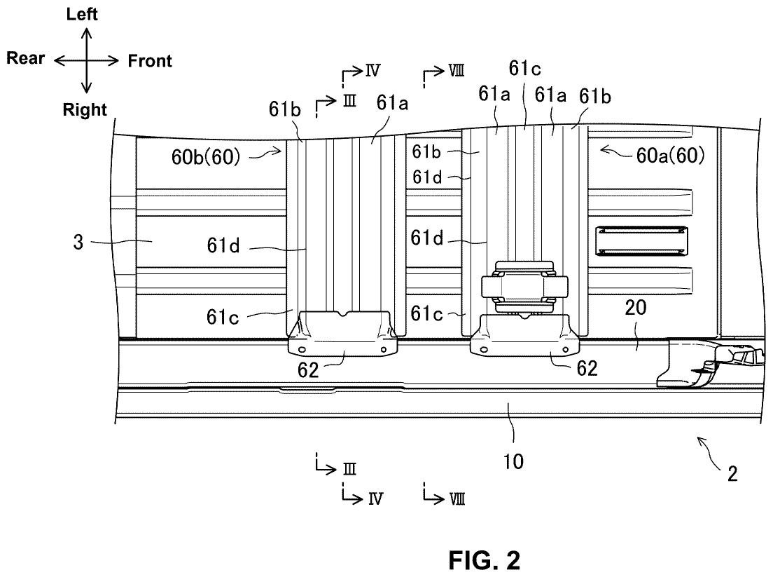

As shown in FIG. 2, the cross member 60 includes a cross-member body 61 and brackets 62. The brackets 62 are fixed to both sides, in the lateral direction, of the cross-member body 61 (the right-side bracket 62 is shown in FIG. 2 only). The left-side bracket 62 is fixed to the left-side side sill 2 by welding, and the right-side bracket 62 is fixed to the right-side side sill 2 by welding. Thereby, the both-side end portions, in the lateral direction, of the cross member 60 are fixed to the side sills 2. A lower end of the cross-member body 61 is fixed to an upper face of the floor panel 3.

The cross-member body 61 has a cross section which is of a M-letter shape. The cross-member body 61 comprises two upper face portions 61a, four side face portions 61b, and a joint face portion 61c which is joined to the floor panel 3. A cross-member ridgeline portion 61d extending in the lateral direction is formed between the upper face portion 61a and the side face portion 61b and also between the joint face portion 61c and the side face portion 61b.

As shown in FIG. 3, a battery B is arranged below the floor panel 3. The battery B is arranged in a state where it is stored in a battery case 70. The battery B is provided in a range which overlaps a roughly whole part of the floor panel 3 in a plan view.

The battery B is supported at lower wall portions (inner lower-wall portions 22 described later) of the side sills 2 together with the battery case 70 via support portions 80. Specifically, a bracket 71 extending outward, in the vehicle width direction, of a vehicle body is fixed to an outward portion, in the vehicle width direction, (to a right-side portion in FIG. 3) of the battery case 70. A bolt 81 is inserted into an outward-side end portion, in the vehicle width direction, (into a right-side end portion in FIG. 3) of the bracket 71. The bolt 81 is supposed to engage with a nut 82 which is fixed to a portion inside the closed-cross section of the inner lower-wall portion 22 of the side sill 2. The bolt 81 is inserted into the bracket 71 from below and fixed by the nut 82. Thereby, the battery B is supported at the side sills 2 via the battery case 70 and the brackets 71. The bolt 81 and the nut 82 constitute a support portion 80. A bush 72 is arranged around the bolt 81 between the bracket 71 and the inner lower-wall portion 22. The bush 72 is made of a resilient member.

### (2) Side Sill

Hereafter, a structure of the side sill 2 will be described specifically. As described above, since the vehicle-body structure of the vehicle 1 is laterally symmetrical, the structure of the right-side side sill 2 will be described specifically, and specific description of the left-side side sill 2 is omitted here. Further, in the description of the right-side side sill 2, the right side corresponds to the outward side, in the vehicle width direction, of the vehicle body and the left side corresponds to the inward side, in the vehicle width direction, of the vehicle body.

### (2-1) Outer Panel, Inner Panel

As shown in FIG. 3, the side sill 2 includes an outer panel 10 positioned on the right side relatively and an inner panel 20 positioned on the left side relatively. A material of the outer panel 10 and the inner panel 21 is not limited to a particular one, but iron is applicable, for example.

The outer panel 10 has a hat-shaped cross section which is open to the left side. The outer panel 10 comprises an outer upper-wall portion 11 which expands in the longitudinal direction and in the lateral direction, an outer lower-wall portion 12 which is provided to face the outer upper-wall portion 11 in a vertical direction and expands in the longitudinal direction and in the lateral direction, and an outer side-wall portion 13 which connects, in the vertical direction, a right-side end portion of the outer upper-wall portion 11 and a right-side end portion of the outer lower-wall portion 12 and expands in the vertical direction and in the longitudinal direction. A pair of outer flanges 14 extend in the vertical direction from a left-side end portion of the outer upper-wall portion 11 and a left-side wall portion of the outer lower-wall portion 12, respectively. The outer upper-wall portion 11 is inclined such that it extends obliquely rightward-and-downward. The outer lower-wall portion 12 is inclined such that it extends obliquely rightward-and-upward. The left-side end portion of the outer upper-wall portion 11 is positioned on the right side of the left-side end portion of the outer lower-wall portion 12.

The inner panel 20 has a hat-shaped cross section which is open to the right side. The inner panel 20 comprises an inner upper-wall portion 21 which expands in the longitudinal direction and in the lateral direction, an inner lower-wall portion 22 which is provided to face the inner upper-wall portion 21 in the vertical direction and expands in the longitudinal direction and in the lateral direction, and an inner side-wall portion 23 which connects, in the vertical direction, a left-side end portion of the inner upper-wall portion 21 and a left-side end portion of the inner lower-wall portion 22 and expands in the vertical direction and in the longitudinal direction. A pair of inner flanges 24 extend in the vertical direction from a right-side end portion of the inner upper-wall portion 21 and a right-side wall portion of the inner lower-wall portion 22, respectively. The inner upper-wall portion 21 is inclined such that it extends obliquely leftward-and-downward. The inner lower-wall portion 22 extends straightly in the lateral direction. The inner lower-wall portion 22 has an insertion hole of the bolt 81.

The outer flanges 14 of the outer panel 10 and the inner flanges 24 of the inner panel 20 are provided to overlap each other in a state where their openings face each other in the lateral direction. The outer flanges 14 and the inner flanges 24 are joined by welding. Thereby, the side sill 2 has the structure having the rectangular-shaped closed-cross section which is formed by the outer upper-wall portion 11, the outer lower-wall portion 12, the outer side-wall portion 13, the inner upper-wall portion 21, the inner lower-wall portion 22, and the inner side-wall portion 23.

The floor panel 3 and the cross member 60 are fixed to the inner panel 20. Specifically, as shown in FIG. 3, the floor-panel joint portion 3b of the floor panel 3 is formed by a right-side end portion of the floor panel body 3a which is bent upward, and extends along the inner side-wall portion 23 and is joined to a left-side face of the inner side-wall portion 23. The bracket 62 of the cross member 60 is provided to cover a corner portion between the inner upper-wall portion 21 and the inner side-wall portion 23. The bracket 62 has a portion for welding which extends continuously along the inner upper-wall portion 21. This welding portion is joined to the inner upper-wall portion 21. Herein, FIG. 3 shows a fixation structure of the rear-side cross member 60 and the inner panel 20. The fixation structure of the front-side cross member 60 and the inner panel 20 are the same as the fixation structure of the rear-side cross member 60 and the inner panel 20.

### (2-2) Reinforcement

As shown in FIG. 3, a reinforcement 7 to reinforce the side sill 2 is arranged inside the closed-cross section of the side sill 2. The reinforcement 7 is formed by pressing of a pipe. The reinforcement 7 extends in the longitudinal direction inside the closed-cross section of the side sill 2. The reinforcement 7 is arranged at a position which overlaps the two cross members 60 in the vertical direction. The material strength of the reinforcement 7 is lower than that of the cross-member body 61. Herein, the material strength means the strength of a plate itself which constitutes the member. The material strength is a parameter to be determined by the tensional strength and the thickness of the plate, for example. The higher the tensional strength is, the higher the material strength is. Also, the larger the thickness is, the higher the material strength is. The material of the reinforcement 7 is not limited to a particular one, but it is iron, for example.

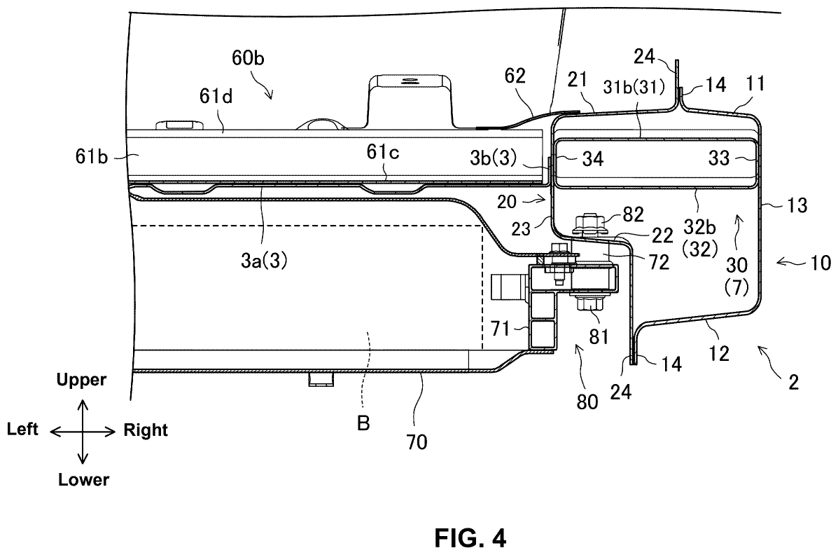

As shown in FIG. 4, the reinforcement 7 has a first area portion 30 which overlaps the cross members 60 in the longitudinal direction and a second area portion 50 which does not overlap the cross members 60 in the longitudinal direction. The first area portion 30 and the second area portion 50 are different from each other in the structure. The first area portion 30 and the second area portion 50 are made of a single member and integrally formed seamlessly.

### (2-2-1) First Area Portion

The first area portion 30 has a structure having a rectangular-shaped closed-cross section. The first area portion 30 includes a first upper-side lateral wall portion 31 which is positioned at a relatively upper side and expands in the longitudinal direction and in the lateral direction and a first lower-side lateral wall portion 32 which is provided to face the first upper-side lateral wall portion 31 in the vertical direction and expands in the longitudinal direction and in the lateral direction. The first area portion 30 includes a first outward-side vertical wall portion 33 which is positioned at a relatively right side and expands in the longitudinal direction and in the vertical direction and a first inward-side vertical wall portion 34 which is provided to face the first outward-side vertical wall portion 33 in the lateral direction and expands in the longitudinal direction and in the vertical direction. The first outward-side vertical wall portion 33 connects, in the vertical direction, a right-side end portion of the first upper-side lateral wall portion 31 and a right-side end portion of the first lower-side lateral wall portion 32. The first inward-side vertical wall portion 34 connects, in the vertical direction, a left-side end portion of the first upper-side lateral wall portion 31 and a left-side end portion of the first lower-side lateral wall portion 32. The first upper-side lateral wall portion 31, the first lower-side lateral wall portion 32, the first outward-side vertical wall portion 33, and the first inward-side vertical wall portion 34 are made of a single member and formed integrally seamlessly.

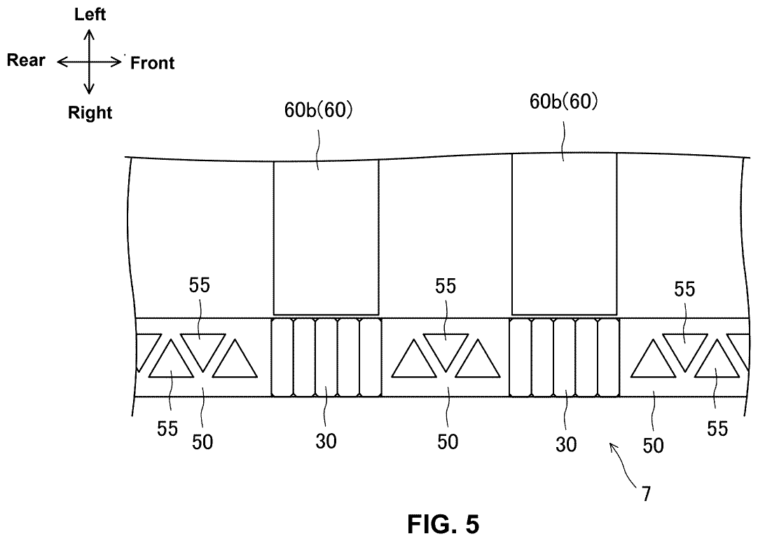

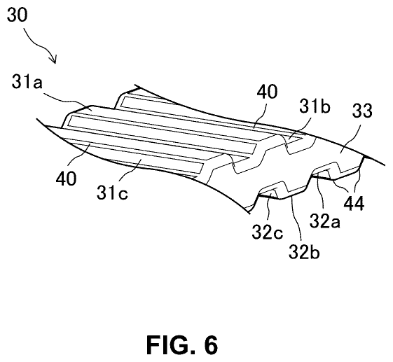

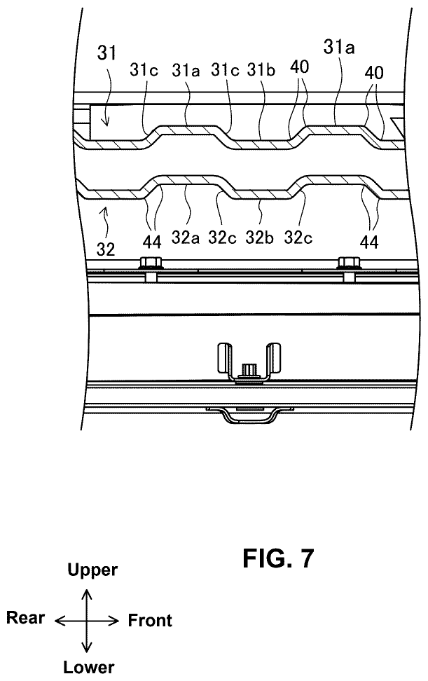

As shown in FIGS. 5 and 6, the first upper-side lateral wall portion 31 is of an uneven (concave-and-convex) shape when viewed in the lateral direction. Specifically, the first upper-side lateral wall portion 31 comprises a first upper-face portion 31a which is relatively positioned at an upper side and expands in the longitudinal direction and in the lateral direction, a second upper-face portion 31b which is relatively positioned at a lower side and expands in the longitudinal direction and in the lateral direction, and an upper-side connection portion 31c which connects, in the vertical direction, an end portion, in the longitudinal direction, of the first upper-face portion 31a and an end portion, in the longitudinal direction, of the second upper-face portion 31b. The first upper-face portion 31a and the second upper-face portion 31b are aligned in the longitudinal direction alternately. The upper-side connection portion 31c to connect the front-side end portion of the first upper-face portion 31a and the rear-side end portion of the second upper-face portion 31b is inclined such that it expands obliquely forward-and-downward. The upper-side connection portion 31c to connect the rear-side end portion of the first upper-face portion 31a and the front-side end portion of the second upper-face portion 31b is inclined such that it expands obliquely forward-and-upward. The width, in the longitudinal direction, of the first upper-face portion 31a is the same as the width, in the longitudinal direction, of the second upper-face portion 31b. The width, in the longitudinal direction, of the first upper-face portion 31a and the second upper-face portion 31b is narrower than the width, in the longitudinal direction, of the cross member 60 and the minimum of a distance between the pair of cross members 60. Specifically, the width, in the longitudinal direction, of the first upper-face portion 31a and the second upper-face portion 31b is narrower than a half of the width, in the longitudinal direction, of the cross member 60 and also narrower than a half of the minimum of the distance between the pair of cross members 60. The length, in the vertical direction, of the upper-side connection portion 31c, i.e., the distance, in the vertical direction, of the first upper-face portion 31a and the second upper-face portion 31b is about ¼ of the distance between the upper-side lateral wall portion 31 and the lower-side lateral wall portion 32.

First upper-side ridgeline portions 40 extending in the lateral direction are formed between the first upper-face portion 31a and the upper-side connection portion 31c and between the second upper-face portion 31b and the upper-side connection portion 31c, respectively. The four first upper-side ridgeline portions 40 are formed by one-cycle uneven shape comprising the first upper-face portion 31a, the second upper-face portion 31b, and the upper-side connection portions 31c. The cycle-number of the uneven shape multiplied by four equals the number of the first upper-side ridgeline portions 40 which are formed at the first upper-side lateral wall portion 31 as a whole.

The vertical position of the first upper-face portion 31a is the same as the vertical position of the upper face portion 61a of the cross member 60. Accordingly, the first upper-side ridgeline portion 40 has the same vertical position as the upper-side cross-member ridgeline portion 61d. Further, the first upper-side ridgeline portion 40 has the same longitudinal position as the upper-side cross-member ridgeline portion 61d.

As shown in FIGS. 5 and 6, the first lower-side lateral wall portion 32 is of an uneven (concave-and-convex) shape when viewed in the lateral direction. Specifically, the first lower-side lateral wall portion 32 comprises a first lower-face portion 32a which is relatively positioned at an upper side and expands in the longitudinal direction and in the lateral direction, a second lower-face portion 32b which is relatively positioned at a lower side and expands in the longitudinal direction and in the lateral direction, and a lower-side connection portion 32c which connects, in the vertical direction, an end portion, in the longitudinal direction, of the first lower-face portion 32a and an end portion, in the longitudinal direction, of the second lower-face portion 32b. The first lower-face portion 32a and the second lower-face portion 32b are aligned in the longitudinal direction alternately. The lower-side connection portion 32c to connect the front-side end portion of the first lower-face portion 32a and the rear-side end portion of the second lower-face portion 32b is inclined such that it expands obliquely forward-and-downward. The lower-side connection portion 32c to connect the rear-side end portion of the first lower-face portion 32a and the front-side end portion of the second lower-face portion 32b is inclined such that it expands obliquely forward-and-upward. The width, in the longitudinal direction, of the first lower-face portion 32a is the same as the width, in the longitudinal direction, of the second lower-face portion 32b. The width, in the longitudinal direction, of the first lower-face portion 32a and the second lower-face portion 32b is the same as the width, in the longitudinal direction, of the first upper-face portion 31a and the second upper-face portion 31b. The vertical length of the lower-side connection portion 32c, i.e., the distance, in the vertical direction, between the first lower-face portion 32a and the second lower-face portion 32b is the same as the vertical distance between the first upper-face portion 31a and the second upper-face portion 31b.

First lower-side ridgeline portions 44 extending in the lateral direction are formed between the first lower-face portion 32a and the lower-side connection portion 32c and between the second lower-face portion 32b and the lower-side connection portion 32c, respectively. The four first lower-side ridgeline portion 44 are formed by one-cycle uneven shape comprising the first lower-face portion 32a, the second lower-face portion 32b, and the lower-side connection portions 32c. The cycle-number of the uneven shape multiplied by four equals the number of the first lower-side ridgeline portions 44 which are formed at the first lower-side lateral wall portion 32 as a whole.

As shown in FIG. 4, the vertical position of the second lower-face portion 32b is the same as the vertical position of the floor panel body 3a. Accordingly, the vertical position of the first lower-side ridgeline 44 is the same as the vertical position of the floor panel body 3a. Further, the vertical position of the second lower-face portion 32b is slightly below the joint face portion 61c of the cross-member body 61. Accordingly, the first lower-side ridgeline portion 44 is positioned slightly below the lower-side cross-member ridgeline portion 61d.

As shown in FIG. 6, the longitudinal position of the first upper-face portion 31a is the same as the longitudinal position of the first lower-face portion 32a. The longitudinal position of the second upper-face portion 31b is the same as the longitudinal position of the second lower-face portion 32b. The longitudinal position of the first upper-side ridgeline portion 40 is the same as the longitudinal position of the first lower-side ridgeline portion 44. Further, the vertical distance between the first upper-face portion 31a and the first lower-face portion 32a, the vertical distance between the second upper-face portion 31b and the second lower-face portion 32b, and the vertical distance between the upper-side connection portion 31c and the lower-side connection portion 32c are the same.

The first outward-side vertical wall portion 33 and the first inward-side vertical wall portion 34 have the shape corresponding to the uneven shape of the first upper-side lateral wall portion 31 and the first lower-side lateral wall portion 32. The first outward-side vertical wall portion 33 is fixed to the outer side-wall portion 13. The first inward-side vertical wall portion 34 is fixed to the inner side-wall portion 23. The respective fixation methods between the first outward-side vertical wall portion 33 and the outer side-wall portion 13 and between the first inward-side vertical wall portion 34 and the inner side-wall portion 23 are not limited to a particular one, but welding, adhesion by an adhesive agent, bolt fastening or the like are applicable, for example.

An area of the closed-cross section which is formed by the first upper-side lateral wall portion 31, the first lower-side lateral wall portion 32, the first outward-side vertical wall portion 33, and the first inward-side vertical wall portion 34 does not change in the longitudinal direction.

### (2-2-2) Second Area

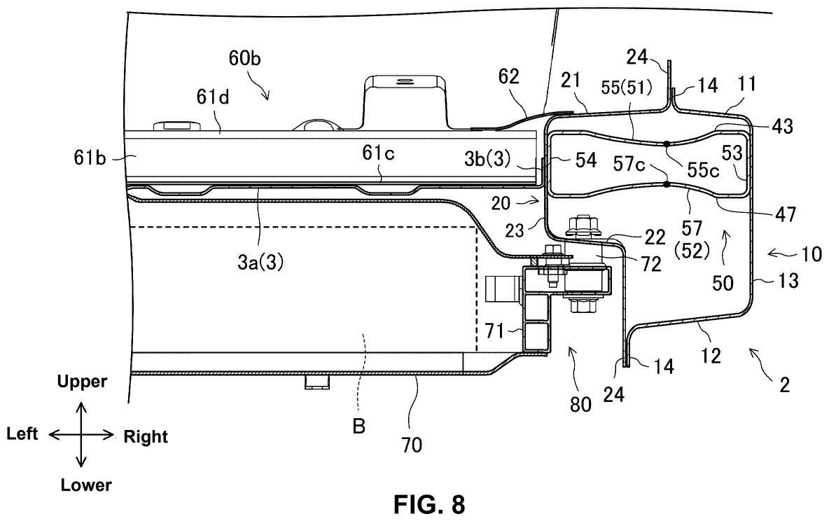

As shown in FIG. 8, the second area portion 50 has a structure having a rectangular closed-cross section. The second area portion 50 includes a second upper-side lateral wall portion 51 which is positioned at a relatively upper side and expands in the longitudinal direction and in the lateral direction and a second lower-side lateral wall portion 52 which is provided to face the second upper-side lateral wall portion 51 in the vertical direction and expands in the longitudinal direction and in the lateral direction. The second area portion 50 includes a second outward-side vertical wall portion 53 which is positioned at a relatively right side and expands in the longitudinal direction and in the vertical direction and a second inward-side vertical wall portion 54 which is provided to face the second outward-side lateral wall portion 53 in the lateral direction and expands in the longitudinal direction and in the vertical direction. The second outward-side vertical wall portion 53 connects respective right-side end portions of the second upper-side lateral wall portion 51 and the second lower-side lateral wall portion 52 in the vertical direction. The second inward-side vertical wall portion 54 connects respective left-side end portions of the second upper-side lateral wall portion 51 and the second lower-side lateral wall portion 52 in the vertical direction. These portions 51, 52, 53, 54 are made of a single member and integrally formed seamlessly. Further, between the first area portion 30 and the second area portion 50, the upper-side lateral portions 31, 51, the lower-side lateral wall portions 32, 52, the outward-side vertical wall portions 33, 53, and the inward-side vertical wall portions 34, 54 are integrally formed seamlessly.

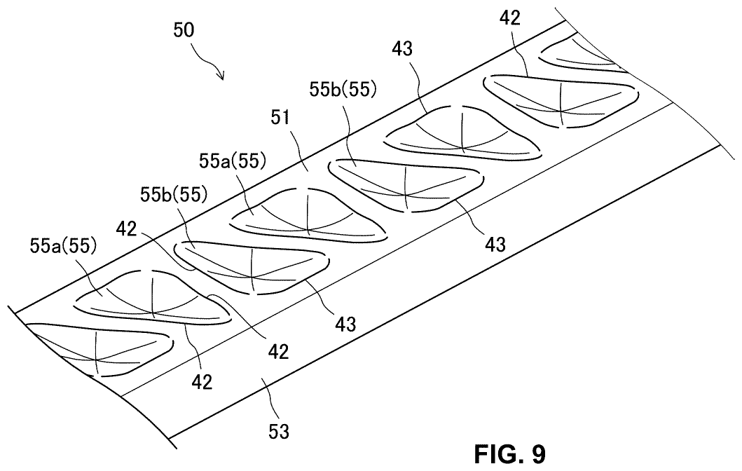

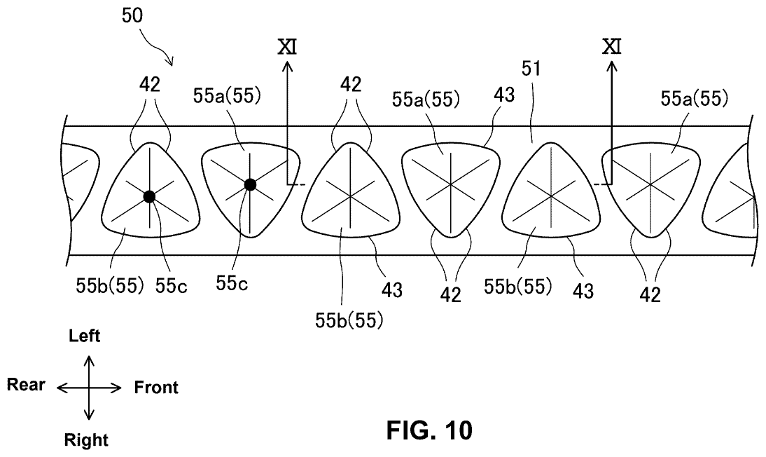

As shown in FIGS. 9 and 10, the second upper-side lateral wall portion 51 has plural upper-side beads 55. The upper-side bead 55 is configured to be recessed downward and has an arc shape. The upper-side bead 55 comprises a first upper-side bead 55a which is of a triangular shape in the plan view and a second upper-side bead 55b which is of the triangular shape in the plan view and has a different facing direction, in the lateral direction, from the first upper-side bead 55a. The first upper-side bead 55a and the second upper-side bead 55b are aligned, in the longitudinal direction, alternately. Hereafter, these beads 55a, 55b will be simply referred to as the upper-side bead 55 when these are not differentiated.

An apex portion 55c of the upper-side bead 55 which is located at a lowermost position is positioned at a center of gravity of the upper-side bead 55. The position of the apex portion 55c is different between the first upper-side bead 55a and the second upper-side bead 55b. The apex portion 55c of the first upper-side bead 55a is positioned on the right side of that of the second upper-side bead 55b.

Two of three sides which form a peripheral edge portion of the upper-side bead 55 are second upper-side ridgeline portions 42 which extend in the lateral direction. Each of the second upper-side ridgeline portions 42 extends longitudinally such that it is inclined relative to the lateral direction. Further, the rest of the three sides of the upper-side bead 55 is a third upper-side ridgeline portion 43 which extends in the longitudinal direction.

The maximum width, in the longitudinal direction, of the upper-side bead 55 is about one third (⅓) of the minimum value of a distance between the front-side cross member 60a and the rear-side cross member 60b.

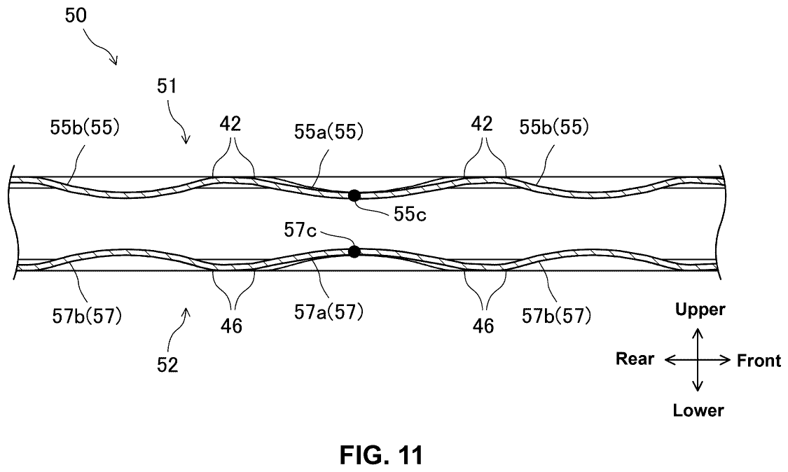

As shown in FIG. 11, the second lower-side lateral wall portion 52 has plural lower-side beads 57. The lower-side bead 57 is configured to be recessed upward and has an arc shape. The lower-side bead 57 comprises a first lower-side bead 57a which is of a triangular shape in the plan view and a second lower-side bead 57b which is of the triangular shape in the plan view and has a different facing direction, in the lateral direction, from the first lower-side bead 57a. The first lower-side bead 57a and the second lower-side bead 57b are aligned, in the longitudinal direction, alternately. Hereafter, these beads 57a, 57b will be simply referred to as the lower-side bead 57 when these are not differentiated.

The lower-side bead 57 is located at the same position, in the longitudinal direction and in the lateral direction, as the upper-side bead 55. Specifically, the first lower-side bead 57a is located at the same position, in the longitudinal direction and in the lateral direction, as the first upper-side bead 55a. The second lower-side bead 57b is located at the same position, in the longitudinal direction and in the lateral direction, as the second upper-side bead 55b. That is, the upper-side beads 55 and the lower-side beads 57 overlap each other in the plan view.

An apex portion 57c of the lower-side bead 57 which is located at an uppermost position is positioned at a center of gravity of the lower-side bead 57. The position of the apex portion 57c is different between the first lower-side bead 57a and the second lower-side bead 57b. The apex portion 57c of the first lower-side bead 57a is positioned on the right side of that of the second lower-side bead 57b. As shown in FIG. 11, the apex portion 57c of the first lower-side bead 57a is located at the same position, in the longitudinal direction and in the lateral direction, at the apex portion 55c of the first upper-side bead 55a. The apex portion 57c of the second lower-side bead 57b is located at the same position, in the longitudinal direction and in the lateral direction, as the apex portion 57c of the second lower-side bead 57b. That is, the apex portion 55c of the upper-side bead 55 and the apex portion 57c of the lower-side beads 57 overlap each other in the plan view.

As shown in FIG. 11, two of three sides which form a peripheral edge portion of the lower-side bead 57 are second lower-side ridgeline portions 46 which extend in the lateral direction. Each of the second lower-side ridgeline portions 46 extends longitudinally such that it is inclined relative to the lateral direction. Further, as shown in FIG. 8, the rest of the three sides of the lower-side bead 57 is a third lower-side ridgeline portion 47 which extends in the longitudinal direction.

The maximum width, in the longitudinal direction, of the lower-side bead 57 is about one third (⅓) of the minimum value of a distance between the front-side cross member 60a and the rear-side cross member 60b.

The surface stiffness (rigidity) of the second upper-side lateral wall portion 51 and the second lower-side lateral wall portion 52 is made relatively large (high) by the upper-side bead 55 and the lower-side bead 57, compared to the first upper-side lateral wall portion 31 and the first lower-side lateral wall portion 32.

The second outward-side vertical wall portion 53 and the second inward-side vertical wall portion 54 extend straightly in the longitudinal direction and in the vertical direction. The second outward-side vertical wall portion 53 is fixed to the outer side-wall portion 13. The second inward-side vertical wall portion 54 is fixed to the inner side-wall portion 23. The respective fixation methods between the second outward-side vertical wall portion 53 and the outer side-wall portion 13 and between the second inward-side vertical wall portion 54 and the inner side-wall portion 23 are not limited to a particular one, but welding, adhesion by an adhesive agent, bolt fastening or the like are applicable, for example.

### (3) Operation (Movement) in Vehicle Side Collision

When a collision object hits against the position of the first area portion 30, a collision load is transmitted to the cross member 60 via the first area portion 30, and received at the cross member 60. Further, the first upper-side ridgeline portion 40 and the first lower-side ridgeline portion 44 at the first area portion 30 near the collision object are compressively deformed, so that the collision load is absorbed. Accordingly, in a case where a pole-side collision occurs at the position of the first area portion 30, the collision load can be absorbed properly.

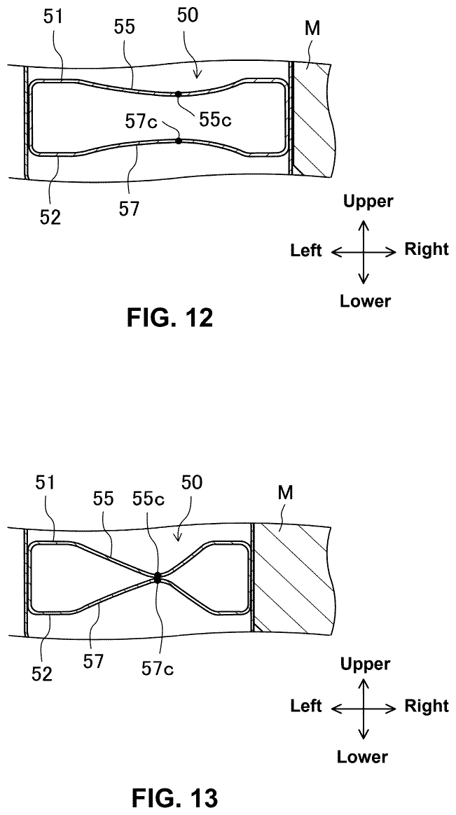

As shown in FIG. 12, when a collision object M collides with the second area portion 50, the deformation of the second upper-side lateral wall portion 51 and the second lower-side lateral wall portion 52 is suppressed by the upper-side bead 55 and the lower-side bead 57. Thereby, the reinforcement 7 moves inward, in the vehicle width direction, of the vehicle body as a whole. Thus, the collision load is transmitted to the cross member 60 via the second area portion 50 and the first area portion 30.

As shown in FIG. 13, as the collision object M further comes in, the second area portion 50 is deformed by the collision load. Herein, the upper-side bead 55 is deformed such that it protrudes downward, and the lower-side bead 57 is deformed such that it protrudes upward. Since the apex portion 55c of the upper-side bead 55 and the apex portion 57c of the lower-side bead 57 overlap each other in the plan view, the upper-side bead 55 and the lower-side bead 57 contact each other by the above-described deformation. Once the upper-side bead 55 and the lower-side bead 57 contract each other, the second area portion 50 is not deformed easily. Accordingly, even if the second upper-side lateral wall portion 51 and the second lower-side lateral 52 start the deformation, the collision load can be transmitted to the cross member 60. Accordingly, even when the pole-side collision occurs at the second area portion 50, the collision load can be absorbed properly.

### (4) Effects of Embodiment

In the present embodiment, the reinforcement 7 includes the first upper-side lateral wall portion 31, the first lower-side lateral wall portion 32, the second upper-side lateral wall portion 51, and the second lower-side lateral wall portion 52 which expand in the vehicle longitudinal direction and in the vehicle width direction, has the first area portion 30 which overlaps the cross members 60 in the vehicle longitudinal direction and the second area portion 50 which does not overlap the cross members 60 in the vehicle longitudinal direction, and the surface stiffness (rigidity) of the second upper-side lateral wall portion 51 and the second lower-side lateral wall portion 52 at the second area portion 50 is larger than that of the first upper-side lateral wall portion 31 and the first lower-side lateral wall portion 32 at the first area portion 30. According to the present embodiment, when the pole-side collision occurs at the first area portion 30, the collision load can be efficiently transmitted to the cross member 60 by the first area portion 30. Meanwhile, when the pole-side collision occurs at the second area portion 50, the absorption amount of the collision load can be improved by the second upper-side lateral wall portion 51 and the second lower-side lateral wall portion 52 which have the relatively-large surface stiffness (rigidity). Further, since the first upper-side lateral wall portion 31, the first lower-side lateral wall portion 32, the second upper-side lateral wall portion 51, and the second lower-side lateral wall portion 52 are merely provided, the increase of the vehicle-body weight can be suppressed. Accordingly, the present embodiment can properly improve the absorption amount of the collision load in the vehicle side collision, suppressing the increase of the vehicle-body weight.

In particular, in the present embodiment, the battery case 70 which stores the battery B is arranged below the floor panel 3. By improving the absorption amount of the collision load at the side sill 2 and the cross member 60, the load transmission to the battery case 70 and the battery B can be suppressed. In the present embodiment, breakage of the battery case 70 and the battery B can be suppressed.

In the embodiment of the present embodiment, the second upper-side lateral wall portion 51 and the second lower-side lateral wall portion 52 have the arc-shaped second upper-side and lower-side beads 55, 57 which protrude in the vertical direction. Thereby, the surface stiffness can be increased by these beads 55, 57. Further, the weight increase of the lateral wall portions 51, 52 is properly small even if these beads are formed. Accordingly, the present embodiment can properly improve the absorption amount of the collision load in the vehicle side collision, suppressing the increase of the vehicle-body weight.

In the present embodiment, the second upper-side lateral wall portion 51 and the second lower-side lateral wall portion 52 have the second upper-side ridgeline portions 42 and the second lower-side ridgeline portions 46 which extend in the vehicle width direction. Thereby, the surface stiffness can be increased by these ridgeline portions 42, 46. Further, the weight increase of the lateral wall portions 51, 52 is small even if these ridgeline portions 42, 46 are formed. Accordingly, the present embodiment can properly improve the absorption amount of the collision load in the vehicle side collision, suppressing the increase of the vehicle-body weight.

Further, in the present embodiment, the second upper-side lateral wall portion 51 and the second lower-side lateral wall portion 52 have the third upper-side ridgeline portions 43 and the third lower-side ridgeline portions 47 which extend in the vehicle longitudinal direction. Thereby, the bending deformation of the second area portion 50 can be suppressed. Accordingly, the present embodiment can improve the absorption amount of the collision load in the vehicle side collision.

In the present embodiment, the upper-side bead 55 is configured to be recessed downward, the lower-side bead 57 is configured to be recessed upward, and the upper-side bead 55 and the lower-side bead 57 overlap each other in the plan view. Accordingly, when the second upper-side lateral wall portion 51 and the second lower-side lateral wall portion 52 are deformed in the vehicle side collision, the upper-side bead 55 is deformed such that it protrudes downward and the lower-side bead 57 is deformed such that it protrudes upward. The upper-side bead 55 and the lower-side bead 57 contact each other due to their deformations. Thereby, the compressive deformation of the lateral wall portions 51, 52 does not occur easily, so that the absorption amount of the collision load is improved. Accordingly, the present embodiment can improve the absorption amount of the collision load in the vehicle side collision.

In the present embodiment, the apex portion 55c of the upper-side bead 55 and the apex portion 57c of the lower-side bead 57 overlap each other in the plan view. Thereby, since the minimum value of the distance between the upper-side bead 55 and the lower-side bead 57 can be made properly small (narrow), the both beads 55, 57 contact each other in an early stage in the vehicle side collision. Accordingly, the present embodiment can improve the absorption amount of the collision load in the vehicle side collision.

In the present embodiment, each of the upper-side bead 55 and the lower-side bead 57 is of the triangular shape in the plan view. Thereby, these beads 55, 57 can be arranged closely. Accordingly, the present embodiment can improve the absorption amount of the collision load in the vehicle side collision.

In the present embodiment, the first upper-side lateral wall portion 31 and the first lower-side lateral wall portion 32 have the first upper-side ridgeline portion 40 and the first lower-side ridgeline portion 44 which extend in the vehicle width direction. Since the rigidity of the first area portion 30 against the collision load applied in the vehicle width direction is increased by these ridgeline portions 40, 44, the collision load can be efficiently transmitted to the cross member 60. Further, since the ridgeline portions 31, 32 are compressively deformed, the collision load can be absorbed. Also, since the ridgeline portions 31, 32 can be formed just by the bending process, forming of the ridgeline portions 31, 32 does not increase the weight of the first upper-side and lower-side lateral wall portions 31, 32 very much. Accordingly, the present embodiment can improve the absorption amount of the collision load in the vehicle side collision, suppressing the vehicle-body weight.

In the present embodiment, the second upper-side lateral wall portion 51, the second lower-side lateral wall portion 52, the second outward-side vertical wall portion 53, and the second inward-side vertical wall portion 54 are integrated. Since the bending deformation of the second upper-side and lower-side lateral wall portions 51, 52 can be suppressed by the second upper-side and lower-side vertical wall portions 53, 54, the present embodiment can improve the absorption amount of the collision load in the vehicle side collision.

(Other Embodiments)

The present invention is not limited to the above-described embodiment, and any modifications are applicable within the claims of the present invention.

While the surface stiffness of the second upper-side lateral wall portion 51 and the second lower-side lateral wall portion 52 is increased more than that of the first upper-side lateral wall portion 31 and the first lower-side lateral wall portion 32 by providing the beads in the above-described embodiment, the material strength of the second upper-side lateral wall portion 51 and the second lower-side lateral wall portion 52 may be increased more than that of the first upper-side lateral wall portion 31 and the first lower-side lateral wall portion 32, for example. Further, the surface stiffness of these portions 51, 52 may be increased by forming flanges at respective both-side end portions, in the lateral direction, of these portions 51, 52 so as to constitute an I-shaped closed-cross-section structure.

While the second area portion 50 comprises the two lateral wall portions of the second upper-side lateral wall portion 51 and the second lower-side lateral wall portion 52 in the above-described embodiment, the single lateral wall portion can be provided only by arranging this lateral wall portion at a position which overlaps the cross member 60 in the vertical direction.

While both of the second upper-side and lower-side lateral wall portions 51, 52 have the beads in the above-described embodiment, the bead may be formed at the second upper-side lateral wall portion 51 only.

While the upper-side bead 55 is configured to be recessed downward and the lower-side bead 57 is configured to be recessed upward in the above-described embodiment, the upper-side bead 55 may be configured to be recessed upward and the lower-side bead 57 may be configured to be recessed downward.

While the second area portion 50 comprises the second outward-side vertical wall portion 53 and the second inward-side vertical wall portion 54 in the above-described embodiment, these portions 53, 54 may be omitted.

While the bead is of the triangular shape in the plan view in the above-described embodiment, it may have a different shape, such as a rectangular shape or a hexagon shape, as long as it is of a polygonal shape in the plan view.

The above-described embodiment merely exemplifies the lower structure of the vehicle according to the present invention, and therefore the present invention is not limited by this embodiment. Any modifications which are specified in the claims and also construed under the doctrine of equivalents should be within the scope of the present invention.

The present invention described above is useful as the lower structure of the vehicle.

What is claimed is:

1. A lower structure of a vehicle, comprising:
a pair of right-and-left side sills extending in a vehicle longitudinal direction and having a closed-cross section;
cross members extending in a vehicle width direction between the pair of side sills and provided to be separated from each other in the vehicle longitudinal direction; and
a reinforcement extending in the vehicle longitudinal direction inside the closed-cross section of each of the pair of side sills at a position, in a vertical direction, thereof which overlaps the cross members and reinforcing the side sill,
wherein said reinforcement includes a lateral wall portion expanding in the vehicle longitudinal direction and in the vehicle width direction, has a first area portion which overlaps said cross members in the vehicle longitudinal direction and a second area portion which does not overlap the cross members in the vehicle longitudinal direction, and surface stiffness of said lateral wall portion at said second area portion is larger than that of said lateral wall portion at said first area portion.

2. The lower structure of the vehicle of claim 1, wherein said lateral wall portion at said second area portion has an arc-shaped bead which protrudes in the vertical direction.

3. The lower structure of the vehicle of claim 2, wherein said lateral wall portion at said second area portion has a ridgeline portion which extends in the vehicle width direction.

4. The lower structure of the vehicle of claim 2, wherein said lateral wall portion comprises an upper-side lateral wall portion which is provided at a relatively upper side and a lower-side lateral wall portion which is provided at a relatively lower side, and each of said upper-side lateral wall portion and said lower-side lateral wall portion at said second area portion has said bead.

5. The lower structure of the vehicle of claim 4, wherein an upper-side bead as said bead provided at said upper-side lateral wall portion is configured to be recessed downward, a lower-side bead as said bead provided at said lower-side lateral wall portion is configured to be recessed upward, and said upper-side bead and said lower-side bead overlap each other in a plan view.

6. The lower structure of the vehicle of claim 5, wherein an apex portion of said upper-side bead and another apex portion of said lower-side bead overlap each other in the plan view.

7. The lower structure of the vehicle of claim 3, wherein said bead is of a polygonal shape in a plan view.

8. The lower structure of the vehicle of claim 3, wherein said bead is of a triangular shape or a rectangular shape in the plan view.

9. The lower structure of the vehicle of claim 1, wherein said lateral wall portion at the first area portion has a ridgeline portion which extends in the vehicle width direction.

10. The lower structure of the vehicle of claim 9, wherein said lateral wall portion comprises an upper-side lateral wall portion which is provided at a relatively upper side and a lower-side lateral wall portion which is provided at a relatively lower side, said reinforcement further includes a pair of right-and-left vertical wall portion which connect respective right-side end portions of said upper-side lateral wall portion and said lower-side lateral wall portion and respective left-side end portions of said upper-side lateral wall portion and said lower-side lateral wall portion in the vertical direction, and said upper-side lateral wall portion, lower-side lateral wall portion, and said pair of right-and-left vertical wall portions are integrated.

11. The lower structure of the vehicle of claim 1, wherein said lateral wall portion at said second area portion has a ridgeline portion which extends in the vehicle width direction.

12. The lower structure of the vehicle of claim 6, wherein said bead is of a polygonal shape in a plan view.

13. The lower structure of the vehicle of claim 2, wherein said lateral wall portion at the first area portion has a ridgeline portion which extends in the vehicle width direction.

14. The lower structure of the vehicle of claim 6, wherein said lateral wall portion at the first area portion has a ridgeline portion which extends in the vehicle width direction.

15. The lower structure of the vehicle of claim 7, wherein said lateral wall portion at the first area portion has a ridgeline portion which extends in the vehicle width direction.

16. The lower structure of the vehicle of claim 2, wherein said lateral wall portion comprises an upper-side lateral wall portion which is provided at a relatively upper side and a lower-side lateral wall portion which is provided at a relatively lower side, said reinforcement further includes a pair of right-and-left vertical wall portion which connect respective right-side end portions of said upper-side lateral wall portion and said lower-side lateral wall portion and respective left-side end portions of said upper-side lateral wall portion and said lower-side lateral wall portion in the vertical direction, and said upper-side lateral wall portion, lower-side lateral wall portion, and said pair of right-and-left vertical wall portions are integrated.

17. The lower structure of the vehicle of claim 6, wherein said lateral wall portion comprises an upper-side lateral wall portion which is provided at a relatively upper side and a lower-side lateral wall portion which is provided at a relatively lower side, said reinforcement further includes a pair of right-and-left vertical wall portion which connect respective right-side end portions of said upper-side lateral wall portion and said lower-side lateral wall portion and respective left-side end portions of said upper-side lateral wall portion and said lower-side lateral wall portion in the vertical direction, and said upper-side lateral wall portion, lower-side lateral wall portion, and said pair of right-and-left vertical wall portions are integrated.

18. The lower structure of the vehicle of claim 7, wherein said lateral wall portion comprises an upper-side lateral wall portion which is provided at a relatively upper side and a lower-side lateral wall portion which is provided at a relatively lower side, said reinforcement further includes a pair of right-and-left vertical wall portion which connect respective right-side end portions of said upper-side lateral wall portion and said lower-side lateral wall portion and respective left-side end portions of said upper-side lateral wall portion and said lower-side lateral wall portion in the vertical direction, and said upper-side lateral wall portion, lower-side lateral wall portion, and said pair of right-and-left vertical wall portions are integrated.
